(19) United States
(12) Patent Application Publication
(10) Pub. No.: US 2025/0337850 A1
(43) Pub. Date: Oct. 30, 2025

(54) STORAGE MEDIUM THAT ENABLES USER TO USE RESOLUTION SETTING FUNCTION, METHOD OF CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: KEITA HIDAKA, Ibaraki (JP)

(21) Appl. No.: 19/185,779

(22) Filed: Apr. 22, 2025

(30) Foreign Application Priority Data
Apr. 25, 2024 (JP) 2024-071327

(51) Int. Cl. H04N 1/00

(52) U.S. Cl. CPC H04N 1/00482; H04N 1/00503; H04N 1/00811; H04N 2201/0094

(57) ABSTRACT

A non-transitory computer-readable storage medium storing an application program supporting scan software which can be commonly used for image processing apparatuses of a plurality of makers. The program is executed to thereby execute a method of controlling an information processing apparatus. A setting screen for receiving a setting of a resolution of an image is displayed. An instruction for reading an image of an original, based on the set resolution, is provided to an image processing apparatus as one of the image processing apparatuses of the plurality of makers. The display screen is capable of receiving a setting of the resolution, which cannot be designated by the scan software.

### BACKGROUND OF THE INVENTION

### Field of the Invention

The present invention relates to a storage medium that enables a user to use a resolution setting function, a method of controlling an information processing apparatus, and an information processing apparatus.

### Description of the Related Art

There is known a configuration that a scan driver installed in a host computer is used as software for controlling a scan device, and a user provides a scan instruction from the host computer to a scan device. In the host computer, an operating system (OS) as basic software is installed, and the scan driver is configured according to specifications defined by the OS and operates when called by the OS. Therefore, the vendor (maker) that provides the scan device provides a scan driver adapted to the specifications of the OS, as means for instructing execution of scan processing to the scan device.

In recent years, in Windows (registered trademark), a standard class driver (hereinafter also referred to as the “standard driver”) which can be commonly used for a scan device provided by a plurality of vendors is provided. The standard driver is incorporated in the package of the OS, and only by connecting a desired scan device to the host computer, the connected scan device easily becomes available. Therefore, it is unnecessary to separately install a scan driver specific to each model, which is adapted to the scan device, giving high convenience. Further, it is assumed that the standard driver is configured to enable a user to designate a scan function based on scan function information of a scan device connected to the host computer. In this case, the user using the standard driver can designate a scan function according to the capabilities of the scan device connected to the host computer only by using one standard driver. However, this is limited to functions which can be realized only by the standard driver, and hence it is impossible to designate a scan function unique to a vendor, which cannot be realized only by the standard driver.

On the other hand, Japanese Laid-Open Patent Publication (Kokai) No. 2021-033526 discloses a program that extends a print function of general-purpose software.

However, there is no disclosure of a program that extends a scan function of the general-purpose software in Japanese Laid-Open Patent Publication (Kokai) No. 2021-033526.

For example, functions of a scan driver unique to a vendor include a resolution setting. The resolution setting is a function which enables a user to set a resolution of an image output after reading performed by the scan device. While the image quality of an output image becomes higher as the set resolution is higher, the data size becomes larger and further time required to perform processing increases, but by using the function, optimum reading according to a resolution set by a user can be performed by the scan device.

However, the standard driver is assumed not to include the resolution setting as a scan function, and in this case, the host computer in which the standard driver has been installed cannot perform scanning with a resolution desired by a user.

### SUMMARY OF THE INVENTION

The present invention provides a storage medium that supports scan software which can be commonly used for image processing apparatuses of a plurality of makers and makes a resolution setting function available to a user, a method of controlling an information processing apparatus, and an information processing apparatus.

In a first aspect of the present invention, there is provided a non-transitory computer-readable storage medium storing an application program supporting scan software which can be commonly used for image processing apparatuses of a plurality of makers, the application program being executed to thereby execute a method of controlling an information processing apparatus, the method including displaying a setting screen for receiving a setting of a resolution of an image, and instructing an image processing apparatus as one of the image processing apparatuses of the plurality of makers to read an image of an original, based on the set resolution, wherein the display screen is capable of receiving the setting of the resolution, which cannot be designated by the scan software.

In a second aspect of the present invention, there is provided an information processing apparatus that is connected to image processing apparatuses of a plurality of makers, and is capable of processing information between the information processing apparatus and an image processing apparatus as one of the image processing apparatuses of the plurality of makers, including scan software which can be commonly used for the image processing apparatuses of the plurality of makers, and an application program supporting the scan software, wherein the application program causes a computer of the information processing apparatus to display a display screen for receiving setting of a resolution of an image; and instruct the image processing apparatus to read an image of an original, based on the set resolution, wherein the display screen is capable of receiving a setting of the resolution, which cannot be designated by the scan software.

According to the present invention, it is possible to support the scan software which can be commonly used for image processing apparatuses of a plurality of makers and make the resolution setting function available to a user. Further features of the present invention will become apparent from

the following description of exemplary embodiments (with reference to the attached drawings).

### BRIEF DESCRIPTION OF THE DRAWINGS

FIG. 1 is a block diagram showing a hardware configuration of a scan system according to a first embodiment.

FIGS. 2A and 2B are block diagrams each showing a software configuration of the scan system.

FIGS. 3A to 3D are diagrams each showing an example of a screen displayed on a display section of the scan system.

FIG. 4 is a flowchart of a process for editing scan function information, which is performed by a scan function-extending unit appearing in FIG. 2B.

FIGS. 5A to 5C are diagrams each showing an example of a list of scan information.

FIG. 6 is a sequence diagram of a process according to the first embodiment, which is performed between a scan application, a general-purpose scan software, an extension application, and a scan device, after the scan application appearing in FIGS. 2A and 2B receives scan setting.

FIG. 7 is a flowchart of a process according to the first embodiment, which is performed by the extension application.

FIG. 8 is a flowchart of a process performed by the scan device having received a scan instruction from the extension application.

FIG. 9 is a flowchart of a scan function information-editing process performed by the scan function-extending unit in a second embodiment.

FIG. 10 is a sequence diagram of a process according to the second embodiment, which is performed between the scan application, the general-purpose scan software, the extension application, and the scan device, after the scan application receives scan setting.

FIG. 11 is a flowchart of a process according to the second embodiment, which is performed by the extension application.

FIG. 12 is a sequence diagram of a process according to a third embodiment, which is performed between the scan application, the general-purpose scan software, the extension application, and the scan device, after the scan application receives scan setting.

FIG. 13 is a sequence diagram of a variation of the process in FIG. 12

FIG. 14 is a sequence diagram of a process according to a fourth embodiment, which is performed between the scan application, the general-purpose scan software, the extension application, and the scan device, after the scan application receives scan setting.

FIG. 15 is a flowchart of a process according to the fourth embodiment, which is performed by the extension application.

### DESCRIPTION OF THE EMBODIMENTS

The present invention will now be described in detail below with reference to the accompanying drawings showing embodiments thereof. However, the configuration described in the following embodiments is given only by way of example, and is by no means intended to limit the scope of the present invention. For example, components of the present invention can be replaced by desired components which can exhibit the same functions. Further, desired components can be added. Further, two or more desired configurations (features) of the embodiments can be combined.

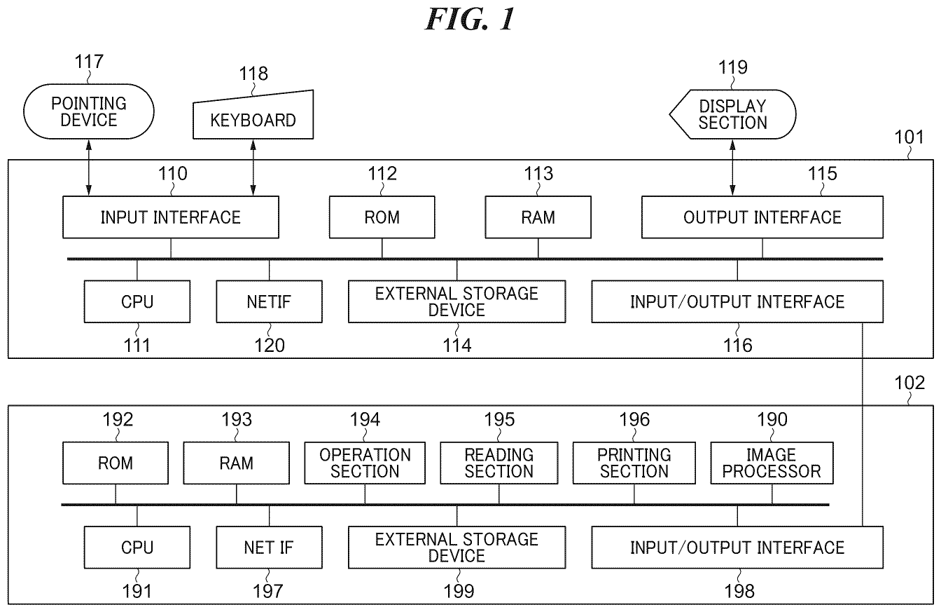

A first embodiment will be described below with reference to FIGS. 1 to 8.

FIG. 1 is a block diagram showing a hardware configuration of the communication system 1000 according to the first embodiment.

As shown in FIG. 1, the scan system 1000 includes a host computer 101, a scan device (scanner) 102 as an example of an image processing apparatus, a pointing device 117, a keyboard 118, and a display section 119, and these are communicably connected to each other.

The host computer 101 is an example of the information processing apparatus and includes an input interface 110, a central processing unit (CPU) 111, a network interface (NET IF) 120, a read only memory (ROM) 112, a random access memory (RAM) 113, an external storage device 114, an output interface 115, and an input/output interface 116. Note that although as the host computer 101, for example, a desktop-type personal computer can be used, this is not limitative, but for example, a laptop-type personal computer, a tablet terminal, or a smartphone can be used.

To the input interface 110, input devices, such as the keyboard 118 and the pointing device 117, are connected, and to the output interface 115, a display device, such as the display section 119, is connected.

The CPU 111 is a computer that executes e.g. programs stored in the ROM 112 and the external storage device 114. Note that in the present embodiment, the CPU 111 is capable of executing functions and processing of the host computer 101 by performing processing according to a program code stored in the ROM 112.

The NET IF 120 is for performing data transfer to and from an external apparatus via a network.

In the ROM 112, an initialization program is stored. The external storage device 114 is e.g. a hard disk drive (HDD) or a solid state drive (SSD). In the external storage device 114, an application program group, an operating system (OS), and other various data are stored. Note that in the present embodiment, as the OS, Windows (registered trademark) 11 of Microsoft (registered trademark) is installed in the host computer 101. The external storage device 114 is not particularly limited, but for example, an HDD or an SSD can be used. The RAM 113 is used e.g. as a work memory when a variety of programs stored in the external storage device 114 are executed, and the variety of programs can operate in the host computer 101.

On the display section 119, for example, a scan setting screen 300A and a detailed setting screen 300C, described hereinafter, are displayed. To the input/output interface 116, a scan device 102 is connected. This enables the host computer 101 to communicate with the scan device 102 as one of respective scan devices of a plurality of makers, i.e. process information with the scan device 102 as the one of the respective scan devices of the plurality of makers regardless of the maker of the scan device 102. The host computer 101 and the scan device 102 can be wiredly connected or wirelessly connected.

The scan device 102 includes an image processor 190, a CPU 191, a ROM 192, a RAM 193, an operation section 194, a reading section 195, a printing section 196, a NET IF 197, and an input/output interface 198.

The CPU 191 is a computer that executes e.g. programs stored in the ROM 192 and the external storage device 199 and performs centralized control of the scan device 102. The ROM 192 is a memory for storing the programs. The RAM 193 is a memory for temporarily storing a program and image data. On the operation section 194, it is possible to provide a variety of operation instructions to the scan device 102. The reading section 195 is a scanner and reads an image from an original. The printing section 196 prints an image on a sheet based on image data generated by reading an image from an original in the reading section 195. Note that the printing section 196 can be omitted. The NET interface 197 performs control to transfer data to and from an external apparatus via a network. To the input/output interface 198, the host computer 101 is connected. To the image processor 190, e.g. image data generated by reading an image from an original in the reading section 195 is input, and the image processor 190 performs various types of edit processing operations on the input image data.

The scan device 102 is not particularly limited insofar as it is an image processing apparatus having an image reading function, i.e. a scan function, but, for example, a multi-function peripheral (MFP) can be used. Further, in a case where the MFP is used as the scan device 102, printing performed by this MFP is printing using the electrophotographic method in the present embodiment but is not limited to this, and, for example, printing using the inkjet method can be performed. Further, although in the present embodiment, the host computer 101 and the scan device 102 are configured as separate apparatuses, this is not limitative. For example, the host computer 101 and the scan device 102 can be configured as an integrated apparatus.

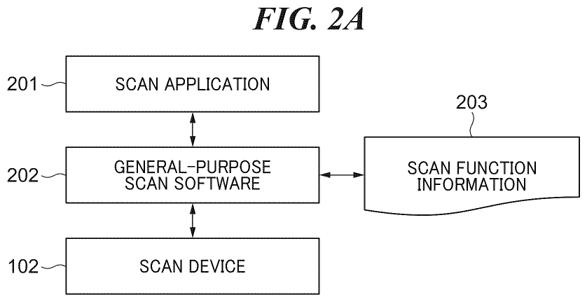

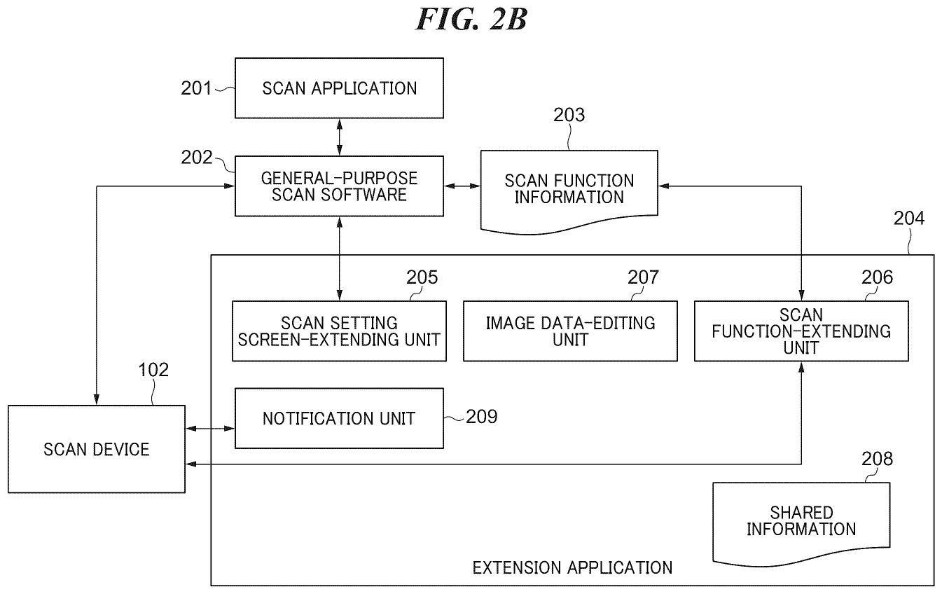

FIGS. 2A and 2B are block diagrams each showing a software configuration of the scan system. The software configuration shown in FIG. 2 is stored in the external storage device 114 appearing in FIG. 1. Note that, here, the scan system using the host computer 101 which has installed Windows (registered trademark) 11 of Microsoft (registered trademark) as the OS will be described by way of example.

FIG. 2A is a diagram showing a general configuration in a case where an extension application (application program) 204 is not associated with general-purpose scan software 202 and the scan device 102. FIG. 2B is a diagram showing a configuration in a case where the extension application 204 is associated with the general-purpose scan software 202 and the scan device 102.

The general-purpose scan software 202 is a general-purpose program which can be commonly used for the scan device 102 as the one of the respective scan devices of a plurality of makers, for example, when scanning (image reading) is performed and is installed in the OS in advance. The extension application 204 supports, i.e. assists the general-purpose scan software 202. In the present embodiment, the extension application 204 is an extension program (program for executing a control method) which can extend a function which cannot be executed by the general-purpose scan software 202 with respect to the scan device 102 but is not limited to this. For example, the extension application 204 can be a program which improves the convenience of a function which can be executed by the general-purpose scan software 202 with respect to the scan device 102. The extension application 204 is stored e.g. in the external storage device 114 with the OS (the general-purpose scan software 202). With this, the host computer 101 has the general-purpose scan software 202 and the extension application 204.

First, referring to FIG. 2A, the configuration of the scan system, which is not associated with the extension application 204 and the scan device 102, will be described.

A scan application 201 is software for capturing contents (image data) generated by scanning performed by the scan device 102. The scan application 201 is not particularly limited, but for example, a document generation application and an image editing application are used. The scan application 201 issues a scan instruction to the OS upon receipt of a scan request e.g. from a user. The scan instruction includes scan setting information for instructing operations of the general-purpose scan software 202 and the scan device 102.

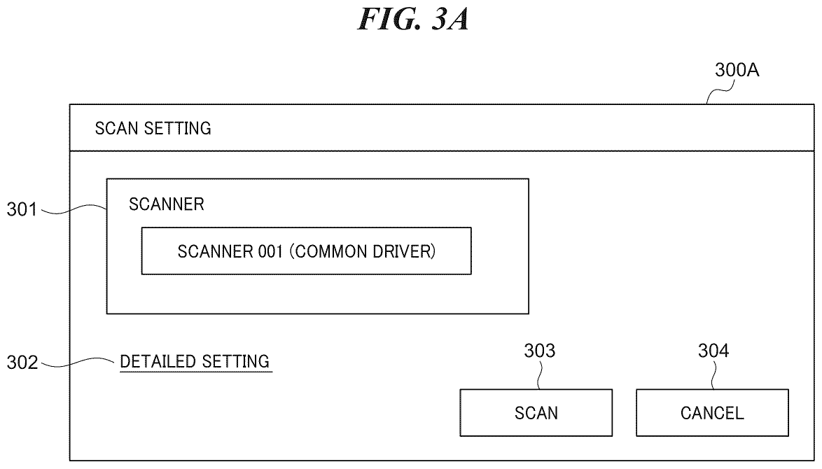

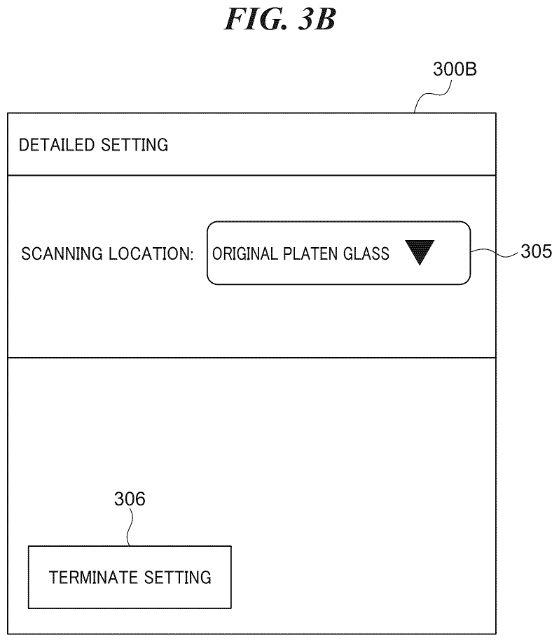

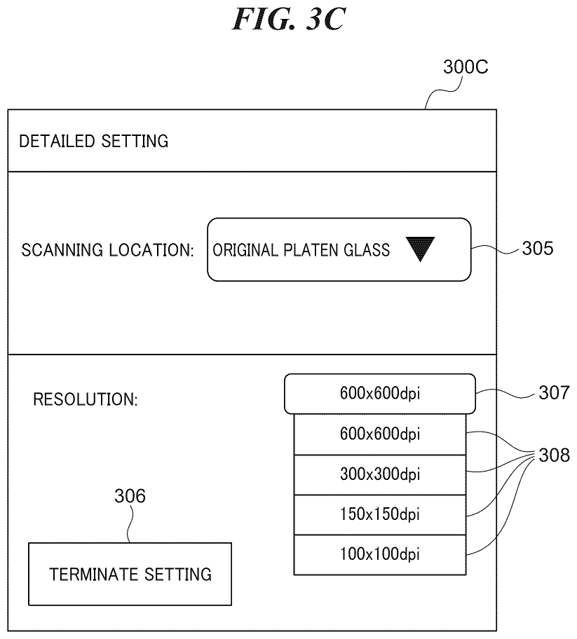

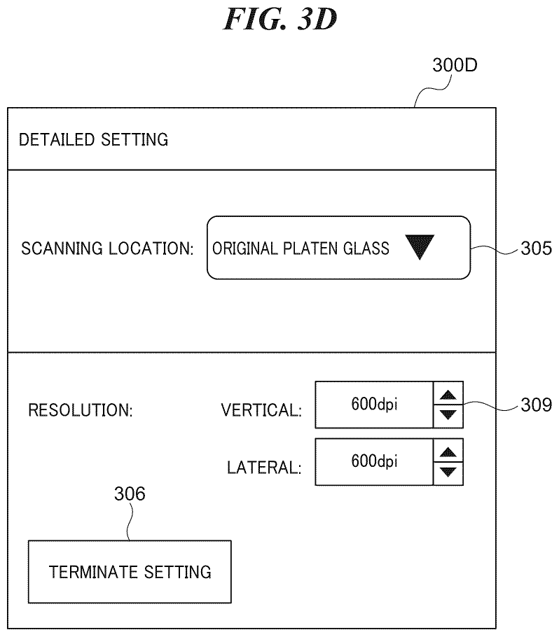

To issue a scan instruction, the scan application 201 can display the scan setting screen 300A (see FIG. 3A) on the display section 119, which is provided by one of the general-purpose scan software 202, the OS, and the scan application 201. Further, when a control 302 in the scan setting screen 300A is operated (pressed), the scan application 201 can display one of detailed setting screens 300B to 300D (see FIGS. 3B to 3D) on the display section 119. The scan setting screen 300A and the detailed setting screens 300B to 300D will be described hereinafter. The scan setting screen 300A includes a setting item indicating a scan function which can be set according to capabilities information acquired by the general-purpose scan software 202, i.e. information which can be set as the scan setting, and a control item for making a setting thereof. The “capabilities information” refers to information related to the capabilities of the scan device 102 for performing scan. Further, with this capabilities information, it is also possible to determine whether or not information which enables the display of the detailed setting screen 300C/300D is included. Then, as a result of this determination, if it is determined that the information which enables the display of the detailed setting screen 300C/300D is included, the detailed setting screen 300C/300D can be displayed. On the other hand, if it is determined that the information which enables the display of the detailed setting screen 300C/300D is not included, the display of the detailed setting screens 300C/300D is inhibited.

Scan function information 203 is data indicating all scan functions which can be set and settings of these scan functions, and a scan function on which e.g. an exclusive relation between settings is described. The scan function information 203 is included in a configuration file of the general-purpose scan software 202 and is disposed in the external storage device 114 as an unchangeable file. Alternatively, the scan function information 203 is dynamically generated by the general-purpose scan software 202. Specifically, the general-purpose scan software 202 acquires attribute data of the scan device 102 from the scan device 102. The general-purpose scan software 202 generates the scan function information 203 according to attribute information in this attribute data. Note that in a case where the scan function information 203 is dynamically generated as described above, the scan function information 203 can be edited. Further, the attribute data of the scan device 102 includes the attribute information indicating the functions which can be designated for the scan device 102 (capabilities of the scan device 102) and settings concerning the attribute information, and these are stored in the RAM 113.

With this configuration, the general-purpose scan software 202 enables a user to designate a scan function which is available in the scan device 102 according to the scan device 102 connected to the host computer 101. With this, regardless of the scan device 102, i.e. even in a case where the scan device 102 having a different function or the scan device 102 developed by a different scanner vendor (maker) is connected, it is possible to designate a scan function which is available in the connected scan device 102. Note that in the present embodiment, the general-purpose scan software 202 is a standard class driver that executes scanning based on a standard scan protocol (instruction protocol) referred to as the Mopria. Specifically, the general-purpose scan software 202 is not a scan driver specific to a model of the scan device 102 but is a standard class driver which can be commonly used for the respective scan devices of a plurality of scanner makers, regardless of the scanner maker. Further, the general-purpose scan software 202 acquires the capabilities information of the scan device 102 and generates the scan function information 203 based on the acquired information.

Further, the general-purpose scan software 202 can be associated with the extension application 204. This enables the general-purpose scan software 202 to execute a function which is not supported by the general-purpose scan software 202. For example, the general-purpose scan software 202 cannot receive a setting of resolution setting for an original (image) to be scanned by the scan device 102. That is, the general-purpose scan software 202 does not support the resolution setting. This is because the resolution setting is a function uniquely executed by the scan device 102 manufactured by a predetermined scanner maker.

The resolution setting function is a function of enabling a user to designate a resolution of an image obtained by the scan application 201 from an original.

The image acquired by the scan application 201 is improved in its image quality as the resolution is higher, but a file size of the image and the processing time increase.

In the present embodiment, the user sets a resolution of an image obtained from an original according to a purpose, by using the resolution setting function, whereby it is possible to suppress increase in the file size and the processing time while obtaining proper image quality.

A case where the extension application 204 is associated with the general-purpose scan software 202 and the scan device 102 will be described with reference to FIG. 2B. As shown in FIG. 2B, differently from FIG. 2A, the extension application 204 is added. That is, the host computer 101 includes the scan application 201, the general-purpose scan software 202, and the scan function information 203, and further has the extension application 204.

The extension application 204 is software for extending the function of the general-purpose scan software 202 and is sometimes simply referred to as the “scan software”. Note that the extension application 204 is software which is not included (packaged) in the OS in advance. Therefore, the extension application 204 is downloaded from a server (not shown) via the Internet and is installed into the host computer 101 by a user operating the host computer 101. Alternatively, when the scan device 102 is connected to the shot computer 101, the extension application 204 can be automatically installed into the host computer 101 upon this connection. Specifically, in a case where the scan device 102 is connected to the shot computer 101, the OS acquires device identification information from the scan device 102. The OS can download the extension application 204 associated with the acquired device identification information from the server via the Internet and install the downloaded extension application 204. As a result, in the host computer 101, the general-purpose scan software 202 and the extension application 204 are stored as control programs independent from each other.

Note that the general-purpose scan software 202 and the extension application 204 are sometimes updated and upgraded in its version, respectively. The processing for updating the general-purpose scan software 202 and the processing for updating the extension application 204 in this case are performed at same timing or at different timings. Further, a trigger for acquiring the general-purpose scan software 202 by the host computer 101 and a trigger for acquiring the extension application 204 can be the same trigger or the different triggers. Further, in a case where the extension application 204 has been installed, the OS associates the extension application 204 with the general-purpose scan software 202 and the scan device 102.

As shown in FIG. 2B, the extension application 204 is capable of exchanging information (transmission and reception of information) with the general-purpose scan software 202 and the scan device 102, respectively. That is, the extension application 204 is associated with the general-purpose scan software 202 and the scan device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write and read information into and from the shared information 208 by using an Application Program Interface (API) provided by the OS.

Note that the extension application 204 can terminate the operation as the whole extension application 204 in accordance with termination of processing executed by each of the scan setting screen-extending unit 205 to the notification unit 209. In this case, the OS starts the extension application 204 whenever a request for using each unit is received. Further, while the processing is being performed by each unit of the scan setting screen-extending unit 205 to the notification unit 209, the extension application 204 can cancel this processing. In this case, a job being processed on a job queue is deleted by the OS.

As described above, upon receipt of a scan request from a user, the scan application 201 issues a scan instruction to the OS. Further, the scan application 201 can display the scan setting screen. In the configuration shown in FIG. 2B, the scan application 201 can display the scan setting screens 300A to 300D provided by the scan setting screen-extending unit 205 (the extension application 204). Further, the scan setting screen-extending unit 205 can store detailed settings made by the user in the shared information 208.

The extension application has the image data-editing unit 207. The image data-editing unit 207 acquires image data from the scan device 102 and edits the acquired image data. Further, the image data-editing unit 207 acquires detailed setting information from the shared information 208 and performs image editing on the image data according to the detailed setting information. The extension application 204 can perform image editing on image data acquired by the general-purpose scan software 202 according to the detailed setting information. Further, in the case of the configuration shown in FIG. 2B as well, there is a case where the resolution setting is not executed by a user. In this case, the general-purpose scan software 202 transmits a scan request instruction to the scan device 102 without using the extension application 204.

The scan function-extending unit 206 can edit the scan function information 203 generated by the general-purpose scan software 202 or the OS. This makes it possible to add a function provided by the extension application 204. Further, the scan function-extending unit 206 can add a function which can be executed in the scan device 102 but cannot be executed by the general-purpose scan software 202 (such as the resolution setting function) and add an exclusive relationship between settings of the scan function. The OS starts the scan function-extending unit 206 when the extension application 204 is associated with the scan device 102 and the general-purpose scan software 202 for the first time. Further, the OS can start the scan function-extending unit 206 at a timing other than this (such as a timing of starting the OS). Since the scan function-extending unit 206 is started as described above, even in a case where a function related to scanning is extended later, the scan function-extending unit 206 can detect the extended function and add the detected function to the scan function information 203.

The notification unit 209 can provide, when an error of the scan device 102 occurs, a notification indicating this fact. For example, if a scan jam error has occurred in the scan device 102, the general-purpose scan software 202 detects occurrence of this error. The OS displays a message showing occurrence of the scan jam error as a result of the detection performed by the general-purpose scan software 202 on the display section 119 by using a notification function referred to as the toast notification as one of the functions of the OS. Note that when the user operates the toast notification, the notification unit 209 is called by the OS, and a user interface screen (UI screen) of the notification unit 209 is displayed. On the user interface screen of the notification unit 209, for example, a detailed message concerning the scan jam error, a jam releasing method, and so forth can be displayed.

As described above, in the present embodiment, it can be said that the extension application 204 has the following four functions: The first function is the function of displaying the setting screen. This function is executed by the scan setting screen-extending unit 205. The second function is the function of editing image data according to the detailed setting information. This function is executed by the image data-editing unit 207. The third function is the function of extending a function which can be designated by using image data generation software. This function is executed by the scan function-extending unit 206. The fourth function is the function of displaying a screen in response to occurrence of an error in the scan device 102. This function is executed by the notification unit 209. Note that the configuration of the extension application 204 is not limited to the configuration having these four functions but is preferable to have at least one function, and further, the extension application 204 can be configured to further have another function.

Next, an example of the scan setting screen and the detailed setting screen in the present embodiment will be described with reference to FIGS. 3A to 3D. FIG. 3A shows the scan setting screen 300A displayed by the scan application 201. FIG. 3B shows the detailed setting screen 300B displayed in the case of the configuration in which the extension application 204 is not associated with the general-purpose scan software 202 and the scan device 102. FIG. 3C shows the detailed setting screen 300C displayed in the case of the configuration in which the extension application 204 is associated with the general-purpose scan software 202 and the scan device 102. Note that a unit or module that displays each screen is not particularly limited. For example, the scan setting screen-extending unit 205 can be configured to generate only a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A is a screen on which a scan condition concerning scanning performed by the scan device 102 can be set. This scan setting screen 300A includes a control (button) 301, a control 302, a control 303, and a control 304. With the control 301, the user can select and set a scanner device used for reading an original. In the illustrated example in FIG. 3A, the scanner device used for reading an original is set to “scanner 001 (common driver)” by way of example. With the control 303, the user can instruct the scan device 102 to start scanning. With the control 304, the user can instruct the scan device 102 to cancel scanning. With the control 302, the user can make detailed settings of the scan condition. When the control 302 is pressed, a detailed setting screen is displayed by the general-purpose scan software 202 or the scan setting screen-extending unit 205.

FIG. 3B shows the detailed setting screen 300B displayed in the case of the configuration in which the extension application 204 is not associated with the general-purpose scan software 202 and the scan device 102. The detailed setting screen 300B includes a control 305 and a control 306. With the control 305, the user can select and set a scanning location of an original, and in FIG. 3B, an original platen glass has been selected by way of example. With the control 306, the user can terminate the setting performed on the detailed setting screen 300B, and when the control 306 is pressed, the screen returns to the scan setting screen 300A (see FIG. 3A).

FIG. 3C shows the detailed setting screen 300C (display screen) displayed in the case of the configuration in which the extension application 204 is associated with the general-purpose scan software 202 and the scan device 102. Differently from the detailed setting screen 300B, the detailed setting screen 300C includes not only the control 305 and the control 306, but also a control 307 and a list 308. With the control 307, the user can perform resolution setting, and in FIG. 3C, “600×600 dpi” is selected as an example of the set resolution. The list 308 is displayed when the control 307 is pressed and indicates that there are resolutions which can be set other than “600×600 dpi” being currently selected. The user can switch the setting of the resolution by selecting a desired resolution from the list 308.

Further, the detailed setting screen 300D (see FIG. 3D), on which an input form and a spin button 309 are disposed, can be displayed in place of the detailed setting screen 300C which prompts a user to select a resolution from the list 308, and a value input by the user can be set as the resolution. The resolution setting can be configured to enable a user to designate resolutions with respect to a vertical direction and a horizontal direction, respectively.

Further, the candidates for the resolution, which are to be displayed in the list 308, can be a plurality of resolutions with which the scan device 102 is capable of performing scanning based on the capabilities information acquired by the scan function-extending unit 206 from the scan device 102 as described hereinafter. Further, the candidates for the resolution, which are to be displayed in the list 308, can be resolutions with which the scan device 102 is capable of performing scanning and which are supported by the extension application 204.

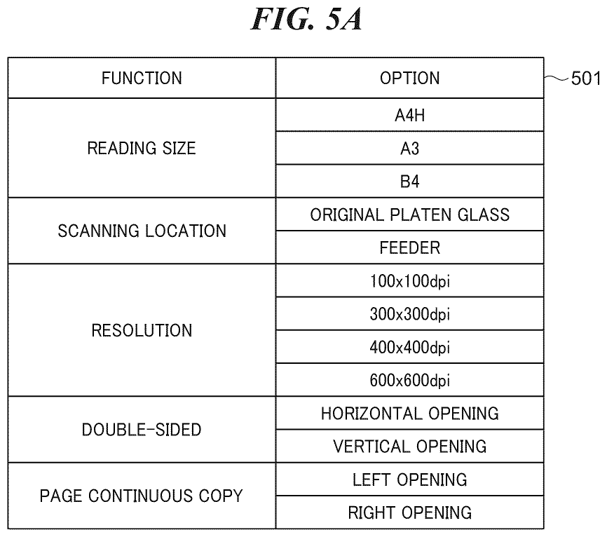

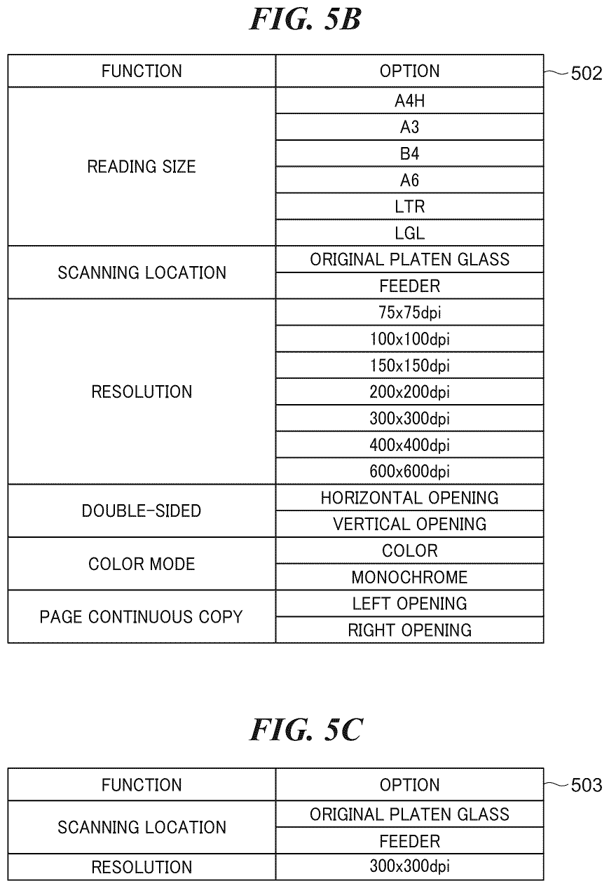

Further, the candidates for the available resolution can be changed and displayed according to a combination of the resolution setting with another setting item (another function), such as an image file format or a color mode. For example, there is a case where the capabilities information of the scan device 102 indicates that the maximum reading resolution in a case where the color mode is set to monochrome is 600×600 dpi, but the maximum reading resolution in a case where the color mode is set to color is 300×300 dpi. In view of this, an item of 600×600 dpi can be inhibited from being displayed in the list 308 in a case where the color mode is set to color. Further, in a case where the control 306 is selected in a state in which 600×600 dpi is selected, a warning message that the selected combination cannot be set can be displayed. This configuration is enabled by defining a resolution for each color mode in the capabilities information 501 (described hereinafter with reference to FIGS. 5A to 5C) of the scan device 102.

Further, in a case where a resolution equal to or higher than a predetermined value, such as 1200×1200 dpi, is designated by operating the spin button 309, a warning message that it can take a very long time to perform reading can be displayed. Note that this warning message can be displayed in a case where the control 306 is selected in a state in which such a resolution is selected.

Here, a reason why the items included in the detailed setting screen 300B shown in FIG. 3B and the items included in the detailed setting screens 300C and 300D, shown in FIGS. 3C and 3D, respectively, are different will be described. That is, a reason why it is possible to switch between display of the detailed setting screen 300B and display of the detailed setting screen 300C or 300D will be described. The detailed setting screens 300B to 300D are generated by referring to the capabilities information generated based on the scan function information. However, as described above, the general-purpose scan software 202 does not support the resolution setting function. Therefore, the resolution setting function cannot be added to the scan function information by the general-purpose scan software 202 alone. Further, even if the resolution setting function has been originally included in the scan function information, the general-purpose scan software 202 can neither interpret the resolution setting function included in the scan function information nor display the setting of the resolution on the detailed setting screen 300B. On the other hand, in a case where the scan function-extending unit 206 adds the resolution setting function to the scan function information 203, the scan setting screen-extending unit 205 can display the detailed setting screen 300C or 300D by consulting the capabilities information. Note that in the detailed setting screen 300C or 300D, an extended function other than the resolution setting function, for example, a reading size setting function, can be additionally included. In this case, an estimate of a volume (size) of scanned image data obtained by scanning an original with the set reading size and resolution can be displayed on the detailed setting screen 300C or 300D.

Further, in a case where a result of scanning with a resolution set on the detailed setting screen 300C or 300D is obtained by pressing the control 303, the scan setting screen-extending unit 205 can display the result of scanning as a preview.

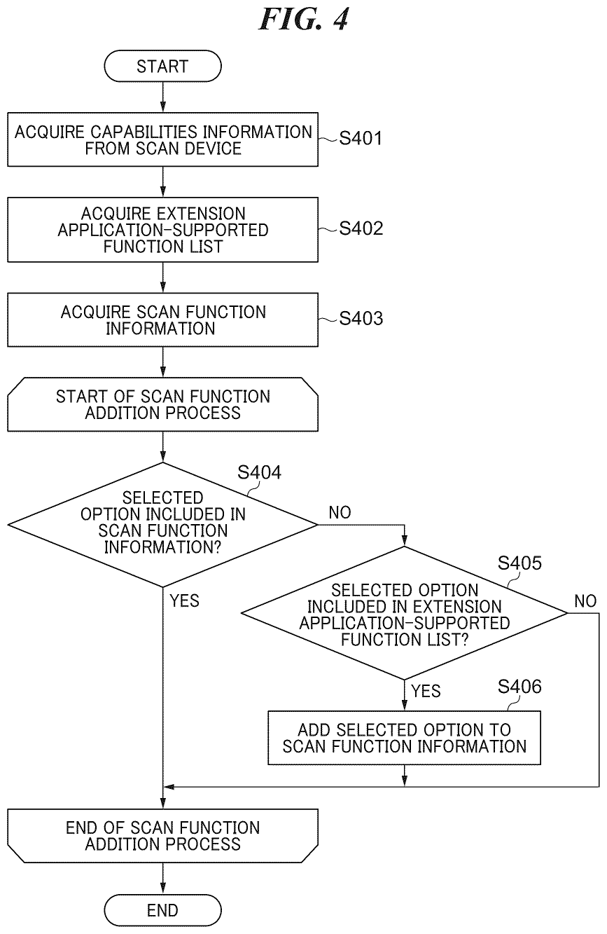

FIG. 4 is a flowchart of a process performed by the scan function-extending unit, for editing the scan function information. Note that the process in FIG. 4 is realized by the CPU 111 that controls the scan function-extending unit 206 loaded from the external storage device 114 into the RAM 113. FIGS. 5A to 5C are diagrams each showing an example of a list of the scan information.

Referring to FIG. 4, first, in a step S401, the scan function-extending unit 206 acquires the capabilities information from the scan device 102. The capabilities information is attribute information indicating the functions which can be designated in the scan device 102 and settings concerning this attribute information. A table 501 shown in FIG. 5A indicates an example of the list of the capabilities information acquired from the scan device 102. As shown in the table 501, the functions, such as the reading size setting, and options which can be set to each function can be acquired from the scan device 102.

In a step S402, the scan function-extending unit 206 acquires a list of scan functions supported by the extension application 204 from the shared information 208. In the shared information 208, the list of the scan functions supported by the extension application 204 is stored. A table 502 shown in FIG. 5B includes all scan functions which can be executed (supported) by the extension application 204 and the settings of these scan functions. For example, the function of the resolution setting has options of “100×100 dpi”, “300×300 dpi”, “400×400 dpi”, and “600×600 dpi”. Further, the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated based on the capabilities information acquired from the scan device 102 by the general-purpose scan software 202. The scan function information 203 generated by the general-purpose scan software 202 includes, out of the capabilities information acquired from the scan device 102, only the scan functions which can be executed by the general-purpose scan software 202. A table 503 shown in FIG. 5C includes all scan functions which can be executed by the general-purpose scan software 202 and the settings of these scan functions. Although the resolution setting function is included in the capabilities information 501 (see FIG. 5A) acquired from the scan device 102, the candidate for the resolution, which can be designated by using the general-purpose scan software, is only one type (300×300 dpi), as shown in the table 503. The scan function-extending unit 206 adds functions and options to the scan function information 203, whereby the extension application 204 can compensate for lack of the functions of the general-purpose scan software 202. Further, the scan function-extending unit 206 can also delete an unnecessary function and options from the scan function information 203 generated by the general-purpose scan software 202.

A step S404, a step S405, and a step S406 are processing operations which are repeatedly executed with respect to the list of the scan functions included in the capabilities information acquired from the scan device 102 in the step S401. In the present embodiment, the steps S404, S405, and S406 are repeatedly executed with respect to all of the nine options (except the double-sided print function and the continuous copy function) included in the table 501 shown in FIG. 5A.

In the step S404, the scan function-extending unit 206 sequentially determines whether or not each of all of the above-mentioned nine options exist in the scan function information 203 generated by the general-purpose scan software 202.

If it is determined that the option as the current determination target exists in the scan function information 203 (YES in S404), the scan function-extending unit 206 determines whether or not the option as the current determination target is the last item of the nine options. As a result of this determination, if it is determined that the option as the current determination target is the last item of the nine options, the present process is terminated, whereas if not, the scan function-extending unit 206 selects the next item of the nine options as the current determination target and executes the step S404 again.

On the other hand, if it is determined that the option as the current determination target does not exist in the scan function information 203 (NO in S404), the process proceeds to the step S405.

For example, in the present embodiment, the scanning location “original platen glass” is included in the table 501, and the scanning location “original platen glass” is also included in the table 503. In this case, it is determined that the option as the current determination target exists in the scan function information 203 (YES in S404). On the other hand, the reading size “A 4H” is included in the table 501 but the reading size “A 4H” is not included in the table 503. In this case, it is determined that the option as the current determination target does not exist in the scan function information 203 (NO in S404).

In the step S405, the scan function-extending unit 206 determines whether or not the option as the current determination target exists in the options supported by the extension application 204. If it is determined that the option as the current determination target exists (YES in S405), the process proceeds to the step S406. On the other hand, if it is determined that the option as the current determination target does not exist (NO in S405), the scan function-extending unit 206 determines whether or not the option as the current determination target is the last item of the nine options. As a result of this determination, if it is determined that the option as the current determination target is the last item of the nine options, the present process is terminated, whereas if not, the scan function-extending unit 206 selects the next item of the nine options as the current determination target and executes the step S404 again.

For example, in the present embodiment, the resolution “600×600 dpi” is included in the table 501, and the resolution “600×600 dpi” is also included in the table 503. Therefore, in a case where the option as the current determination target is the resolution “600×600 dpi”, it is determined that the option as the current determination target exists in the options supported by the extension application 204 (YES in S405).

In the step S406, the scan function-extending unit 206 adds the option as the current determination target to the scan function information 203. After that, the scan function-extending unit 206 determines whether or not the option as the current determination target is the last item of the nine options. As a result of this determination, if it is determined that the option as the current determination target is the last item of the nine options, the present process is terminated, whereas if not, the scan function-extending unit 206 selects the next item of the nine options as the current determination target and executes the step S404 again.

As described above, in the present process, the extension application 204 adds an option which is not supported by the general-purpose scan software 202 but supported by the scan device 102 and the extension application 204 to the scan function information 203. Further, the capabilities information is generated based on the scan function information 203 to which the option has been thus added. Further, the scan setting screen-extending unit 205 generates a display screen based on this generated capabilities information. This makes it possible to extend the function which is not supported by the general-purpose scan software 202 and display the detailed setting screen 300C or 300D shown in FIG. 3C or 3D.

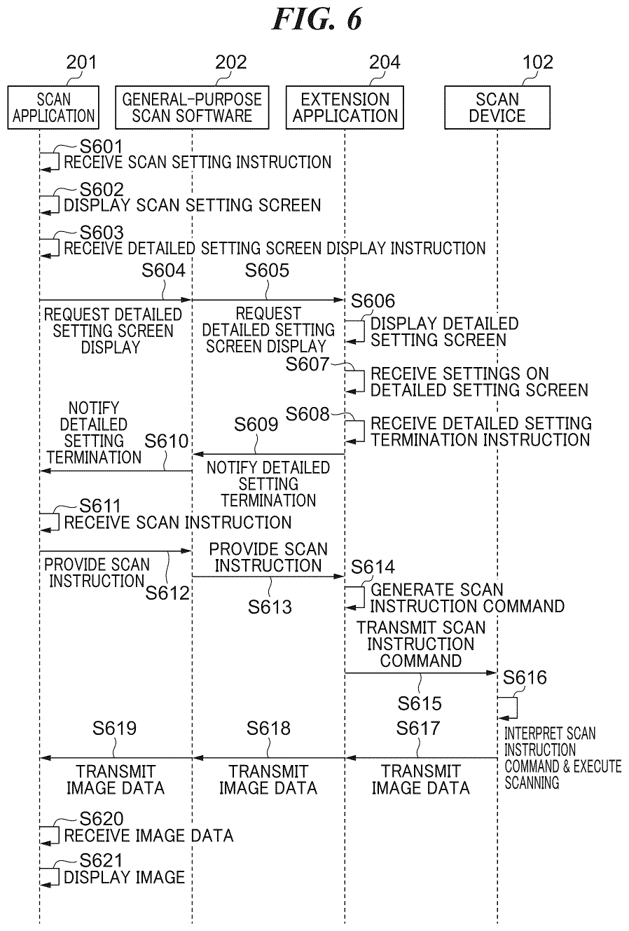

FIG. 6 is a sequence diagram showing a process executed between the scan application 201, the general-purpose scan software 202, the extension application 204, and the scan device 102 after the scan application 201 receives scan setting. The steps in FIG. 6, other than the steps executed by the scan device 102, are performed by the CPU 111 that loads the scan application 201, the general-purpose scan software 202, and the extension application 204 from the external storage device 114 into the RAM 113 and executes the loaded applications. Further, the steps in FIG. 6, executed by the scan device 102, are realized by the CPU 191 of the scan device 102, which loads an associated program stored in the ROM 192 or the external storage device 199 into the RAM 193 and executes the loaded program.

In a step S601, the scan application 201 receives scan setting by a user. The user can instruct the scan setting to the scan application 201 by operating the pointing device 117 and/or the keyboard 118.

In a step S602, the scan application 201 displays the scan setting screen 300A shown in FIG. 3A on the display section 119.

In a step S603, the scan application 201 receives a detailed setting instruction provided by the user. The user can instruct the detailed setting by operating e.g. the pointing device 117 and/or the keyboard 118 to select the control 302 on the scan setting screen 300A.

In a step S604, the scan application 201 requests the general-purpose scan software 202 to display the detailed settings.

In a step S605, the general-purpose scan software 202 requests the extension application 204 to display the detailed settings. The following description will be given of a case where the scan application 201 is in the scan system configured as shown in FIG. 2B, and the general-purpose scan software 202 causes the extension application 204 to display the detailed setting screen 300C shown in FIG. 3C according to this display request.

In a step S606, the scan setting screen-extending unit 205 of the extension application 204 displays the detailed setting screen 300C shown in FIG. 3C on the display section 119 in response to the request received in the step S605. As described above with reference to FIG. 4, in a case where the resolution setting has been added to the scan function information 203 by the scan function-extending unit 206, the scan setting screen-extending unit 205 consults the capabilities information generated based on this scan function information 203 to which the resolution setting has been added. Then, the scan setting screen-extending unit 205 displays the detailed setting screen 300C shown in FIG. 3C on the display section 119. Note that the scanning location or the like can be displayed or inhibited from being displayed or displayed in a grayed-out state, as required.

In a step S607, the scan setting screen-extending unit 205 receives the detailed settings, input by the user on the detailed setting screen 300C. Here, as shown in FIG. 3C, a case where the scanning location “original platen glass” and the resolution “600×600 dpi” are selected as the detailed settings will be described. The received detailed settings are stored in the RAM 113 by the CPU 111.

In a step S608, the scan setting screen-extending unit 205 receives termination of the detailed setting performed by the user based on an operation of the control 306 in the step S607. The user can instruct termination of the detailed setting by operating e.g. the pointing device 117 and/or the keyboard 118 to select the control 306. With this, the settings made on the detailed setting screen 300C are written into the scan function information 203. Note that the information written into the scan function information 203 can also include the above-mentioned information inhibited from being displayed or displayed in the grayed-out state, which the user is not prompted to select.

Upon receipt of termination of the detailed setting in the step S608, in a step S609, the extension application 204 transmits detailed setting termination information to the general-purpose scan software 202.

Upon receipt of the detailed setting termination information transmitted from the extension application 204 in the step S609, in a step S610, the general-purpose scan software 202 transmits the detailed setting termination information to the scan application 201.

In a step S611, the scan application 201 receives a scan instruction provided by the user. The user can provide a scan instruction by operating e.g. the pointing device 117 and/or the keyboard 118 to select the control 303 on the scan setting screen 300A (see FIG. 3A).

In a step S612, the scan application 201 provides the scan instruction received in the step S611 to the general-purpose scan software 202.

Upon receipt of the scan instruction transmitted from the scan application 201 in the step S612, in a step S613, the general-purpose scan software 202 provides this scan instruction to the extension application 204.

Upon receipt of the scan instruction transmitted from the general-purpose scan software 202 in the step S613, in a step S614, the extension application 204 generates a scan instruction command based on the scan function information 203 in which the settings made on the detailed setting screen 300C have been written in the step S608. Note that this scan instruction command includes the set resolution (resolution “600×600 dpi”) received on the detailed setting screen 300C. Further, as described above in the step S608, there is a case where the information inhibited from being displayed or displayed in the grayed-out state, which the user is not prompted to select, has not been written into the scan function information 203. In this case, in the step S614, the extension application 204 can add the information which has not been written into the scan function information 203 to the scan instruction command or set the same as a default value.

In a step 615, the extension application 204 transmits the scan instruction command generated in the step S614 to the scan device 102.

In a step S616, in the scan device 102, upon receipt of the scan instruction command transmitted in the step S615, the input/output interface 198 transfers the received scan instruction command to the reading section 195. The reading section 195 interprets the scan instruction command transferred from the input/output interface 198, executes scanning under the scan condition set on the detailed setting screen 300C, and performs necessary image processing on the image data according to the scan instruction command. In the present embodiment, the set resolution (resolution “600×600 dpi”) has been received on the detailed setting screen 300C, and hence image data with the resolution of 600×600 dpi is generated by the scan processing.

In a step S617, the input/output interface 198 of the scan device 102 transmits the image data generated in the step S616 to the extension application 204.

In a step 618, upon receipt of the image data transmitted from the scan device 102 in the step S617, the extension application 204 transmits this image data to the general-purpose scan software 202.

In a step S619, upon receipt of the image data transmitted from the extension application 204 in the step S618, the general-purpose scan software 202 transmits this image data to the scan application 201.

In a step S620, the scan application 201 receives the image data transmitted from the general-purpose scan software 202 in the step S619, and proceeds to a step S621.

In the step S621, the scan application 201 displays the image data received in the step S620 on the display section 119. As a result, a result of reading the original in the step S616 is displayed on the display section 119 as a preview image. Then, the present process is terminated.

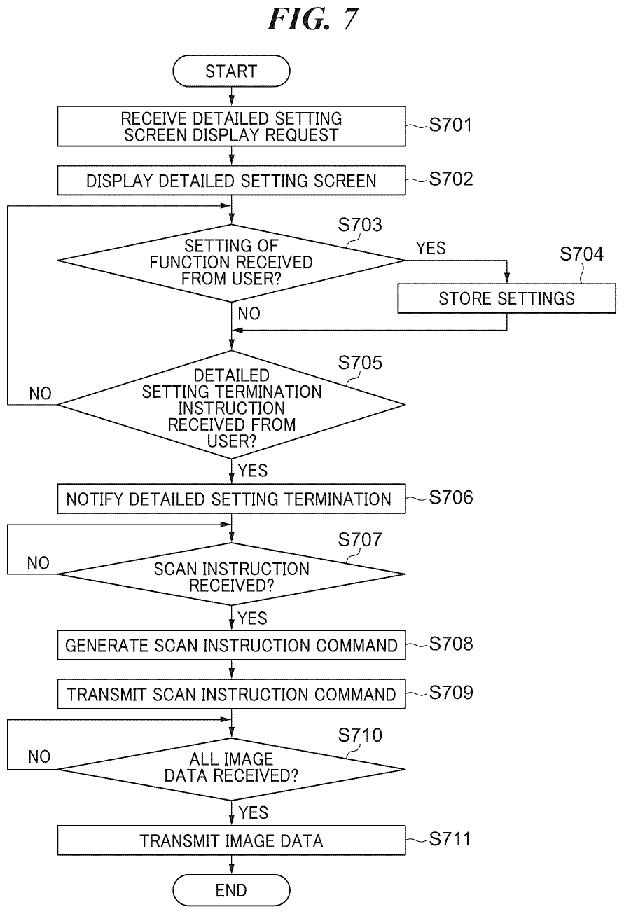

FIG. 7 is a flowchart of the process according to the present embodiment, which is performed by the extension application 204. The present process is realized by the CPU 111 that executes the units loaded from the external storage device 114 into the RAM 113.

First, in a step S701, the extension application 204 receives the request for displaying the detailed settings (see the step S605) from the general-purpose scan software 202.

In a step S702, the scan setting screen-extending unit 205 of the extension application 204 displays the detailed setting screen 300C shown in FIG. 3C on the display section 119. This is because, as described above with reference to FIG. 4, the resolution setting has been added to the scan function information by the scan function-extending unit 206. The scan setting screen-extending unit 205 displays the detailed setting screen 300C shown in FIG. 3C by consulting the capabilities information generated based on the scan function information to which the resolution setting has been added.

In a step S703, the scan setting screen-extending unit 205 determines whether or not the detailed setting has been performed by the user on the detailed setting screen 300C, i.e. whether or not a selection operation has been performed with respect to the control 305 and/or the control 307. If it is determined that the detailed setting has been performed (YES in S703), the process proceeds to a step S704, whereas if it is determined that the detailed setting has not been performed (NO in S703), the process proceeds to a step S705.

In the step S704, the scan setting screen-extending unit 205 stores (saves) settings (setting information) made on the detailed setting screen 300C into the RAM 113 and proceeds to the step S705.

In the step S705, the scan setting screen-extending unit 205 determines whether or not a detailed setting termination instruction has been provided on the detailed setting screen 300C, i.e. whether or not the control 306 has been operated. If it is determined that a detailed setting termination instruction has been provided (YES in S705), the setting information stored in the RAM 113 is written into the scan setting information, and then the process proceeds to a step S706. On the other hand, if it is determined that a detailed setting termination instruction has not been provided (NO in S705), the process returns to the step S703, and the scan setting screen-extending unit 205 determines again whether or not the detailed setting has been performed by the user.

In the step S706, the extension application 204 transmits a detailed setting termination notification to the general-purpose scan software 202.

In the following step S707, the extension application 204 determines whether or not a scan instruction has been provided from the general-purpose scan software 202 (see the step S613). If it is determined that a scan instruction has been provided (YES in S707), the process proceeds to a step S708. On the other hand, if it is determined that a scan instruction has not been provided (NO in S707), the process returns to the step S707, and the extension application 204 determines again whether or not a scan instruction has been provided from the general-purpose scan software 202.

In the step S708, the extension application 204 generates a scan instruction command based on the scan setting information into which the setting information has been written in the step S705. As described above, in this scan instruction command, the set resolution (resolution “600×600 dpi”) received on the detailed setting screen 300C is included.

As the method of generating a scan instruction command in the step S708, a method of extending a standard protocol command can be used. Further, as this extension method, a method of describing a dedicated command in an extended area of the standard protocol command can be used. Further, a method of adding an original standard command (extended instruction command) which is not supported by the standard protocol to the end of the standard protocol command, a method of overwriting the standard protocol command with an command system specific to the extension application 204, and so forth can be used. Further, in a case where an instruction is provided from the extension application 204, communication for an instruction can be performed according to a protocol unique to a maker regardless of the standard protocol.

In the following step S709, the extension application 204 transmits the scan instruction command generated in the step S708 to the scan device 102.

In the following step S710, the extension application 204 determines whether or not all of the scanned image data (see the step S617) have been received from the scan device 102. If it is determined that all of the scanned image data have been received (YES in S710), the process proceeds to a step S711. On the other hand, if it is determined that all of the scanned image data have not been received (NO in S710), the process remains in the step S710, and the extension application 204 determines again whether or not all of the scanned image data have been received from the scan device 102.

In the step S711, the extension application 204 transmits all of the scanned image data received from the scan device 102 to the general-purpose scan software 202, followed by terminating the present process.

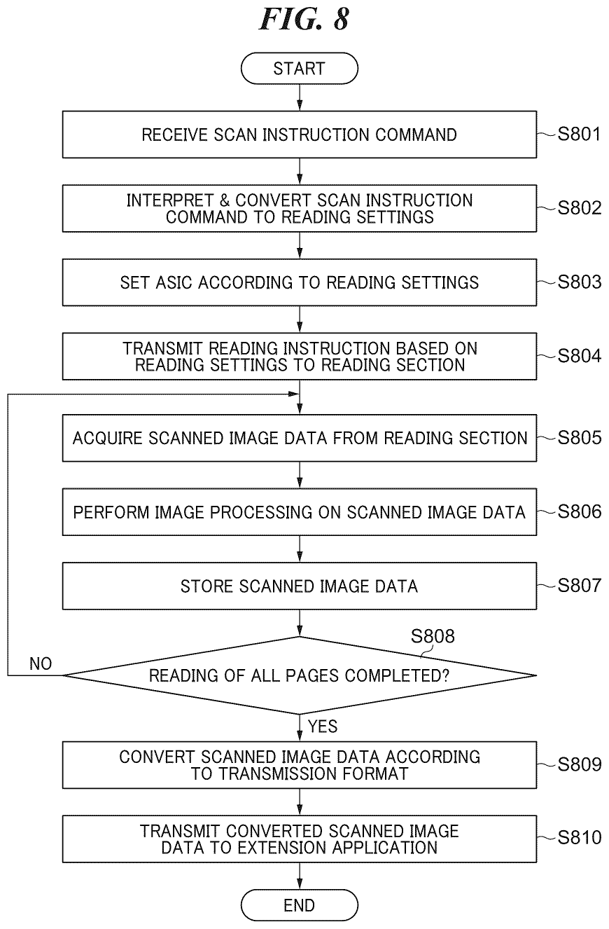

FIG. 8 is a flowchart of the process performed by the scan device 102 having received the scan instruction from the extension application 204. The process in FIG. 8 is realized by the CPU 191 that loads an associated program stored in the external storage device 199 into the RAM 192.

In a step S801, the CPU 191 receives the scan instruction command transmitted from the extension application 204 (see the step S615).

In a step S802, the CPU 191 analyzes the scan instruction command received in the step S801 and converts the scan instruction command to settings with which the scan device 102 is capable of executing scan processing.

That is, the CPU 191 converts the scan instruction command to settings with which scan processing can be performed under the scan condition set on the detailed setting screen 300C. In the present embodiment, reading settings for reading an original on the original platen glass with the set resolution of 600×600 dpi are made. Since the reading size is not designated, the reading size is set, for example, to A 4H size as a default setting.

In a step S803, the CPU 191 determines an application specific integrated circuit (ASIC) of the image processor 190, to be used to execute scanning based on the reading settings converted in the step S802 and performs setting for the ASIC.

In the following step S804, the CPU 191 transmits a scan instruction based on the reading settings to the reading section 195. In the present embodiment, the CPU 191 transmits the scan instruction for reading an original on the original platen glass with the reading size of A 4H and the set resolution of 600×600 dpi.

In the following step S805, the CPU 191 acquires the scanned image data from the reading section 195. In the present embodiment, the CPU 191 acquires the image data of the A 4H size as the scanned image data.

In the following step S806, the CPU 191 controls the image processor 190 to execute image processing on the scanned image data acquired in the step S805. In the present embodiment, the reading section 195 is capable of performing reading with the resolution of 600×600 dpi, the scanned image data is acquired with the resolution of 600×600 dpi by the reading section 195, and hence image processing is not performed in the step S806.

Note that in a case where the reading setting converted in the step S802 or the set resolution in the scan instruction provided in the step S804 are set to 300×300 dpi, in the present embodiment, after the original is read with 600×600 dpi by the reading section 195, the resolution is converted to 300×300 dpi by the image processor 190. However, the reading section 195 can read the original with 300×300 dpi, and resolution conversion by the image processor 190 can be omitted.

In the following step S807, the CPU 191 saves the scanned image data in the external storage device 199.

In the following step S808, the CPU 191 determines whether or not the scan processing of all of the pages of the origin has been completed. If it is determined that the scan processing of all of the pages has not been completed (NO in S808), the process returns to the step S805, and the scan processing of the next page is executed. On the other hand, if it is determined that the scan processing of all of the pages has been completed (YES in S808), the process proceeds to a step S809.

In the step S809, the CPU 191 controls the image processor 190 to convert the scanned image data saved in the step S807 according to a transmission format received in the step S801. In the present embodiment, the transmission format is not included in the scan instruction command received from the extension application 204 in the step S801, and hence the scanned image data is converted to JPEG as the default setting of the scan device 102. However, the transmission format to which the scanned image data is converted is not limited to this but can be any other format insofar as it can be used by the information processing apparatus.

In the following step S810, the CPU 191 controls the input/output interface 198 to transmit the scanned image data formed by conversion in the step S809 to the extension application 204. Then, the present process is terminated.

As described above, in the present embodiment, the scan setting screen-extending unit 205 of the extension application 204 corrects the scan function information 203 based on the general-purpose scan software 202, the extension application 204, and the capabilities information of the scan device 102. Further, when the detailed setting screen is requested from the user, it is possible to prompt the user to set the resolution by displaying the setting screen based on the capabilities information generated from the scan function information 203. After that, when the scan device 102 receives a scan instruction on which the resolution set by the user is reflected, the scan device 102 reads the original with the set resolution. By performing a series of the above-described processing operations, it is possible to cause the scan device 102 to realize the resolution setting function, and it is possible to provide the resolution setting function to the user.

Note that although in the present embodiment, the description has been given using the detailed setting screen 300C shown in FIG. 3C with the configuration shown in FIG. 2B, the present invention is not limited to this. For example, in a case where the detailed setting display request is made to the general-purpose scan software 202 in the step S604, the general-purpose scan software 202 can display the detailed setting screen 300B shown in FIG. 3B. Then, after the detailed setting in FIG. 3B is terminated, the general-purpose scan software 202 requests the extension application 204 to display the detailed setting screen 300C. In response to this request, the extension application 204 can additionally display the detailed setting screen 300C on which the resolution setting can be performed.

Further, although the general-purpose scan software 202 provides a scan instruction to the extension application 204, this is not limitative. For example, the scan application 201 can directly provide a scan instruction to the extension application 204, or the user can directly provide an instruction to the extension application 204 using a control provided on the detailed setting screen for instructing scan. Further, as the method of transferring scanned image data, the extension application 204 can directly transfer the image data to the scan application 201 without using the general-purpose scan software 202, or can transfer the image data from the scan device 102 to the scan application 201. Further, the received image data can be stored in the external storage device 114, and only information on a file path indicating the storage location can be transferred.

Further, although in the present embodiment, in a case where a plurality of scanned image data are obtained, transfer of image data is started after all of the image data are received, the transmitted scanned image data can be transferred as required.

Next, a second embodiment will be described. In the above-described first embodiment, the scan setting information including the resolution setting is interpreted on the side of the scan device 102, and scan processing using the designated resolution setting function is performed on the side of the scan device 102.

However, there is a case where the resolution with which reading can be performed is limited, e.g. due to the costs taken into account, depending on the scan device 102. In this case, even when the extension application 204 supports the resolution setting function, and the scan setting information including the resolution setting can be generated, it is impossible to cause the scan device 102 to execute scan processing with the designated resolution.

To solve this problem, in the second embodiment, first, the resolution setting with which the scan device 102 can perform reading is determined based on the capabilities information of the scan device 102. Next, if the designated resolution is a resolution with which the scan device 102 is capable of performing reading, the scan setting information including the resolution setting function designated by the user is generated and passed to the scan device 102. On the other hand, in a case where the designated resolution is not a resolution with which the scan device 102 is capable of performing reading, the scan setting information of a setting of resolution higher than the resolution designated by the user is generated and passed to the scan device 102. Then, the resolution of scanned image data read by the scan device 102 is converted by the extension application 204. With this, it is also possible to provide a resolution setting function of a resolution designated by the user and not supported by the scan device 102.

Note that in the description of the present embodiment, the same components as those of the first embodiment are denoted by the same reference numerals, the redundant description is omitted, and the description will be given only of a difference from the first embodiment.

In the present embodiment, it is assumed that the scan device 102 is a scan device which does not support the resolution setting of 150×150 dpi. Therefore, in the capabilities information acquired from the scan device 102, 150×150 dpi is not included in the resolution setting. On the other hand, in the present embodiment, the extension application 204 supports the resolution setting of 150×150 dpi. In this case, if a unit that performs resolution conversion on image data is included in the extension application 204, the scan function-extending unit 206 adds the resolution setting of 300×300 dpi with which the scan device 102 can perform reading to the scan function information 203. The image data-editing unit 207 performs resolution conversion processing of the image data received from the scan device 102, for converting the resolution to 150×150 dpi, based on the resolution setting by the user. Details will be described hereinafter.

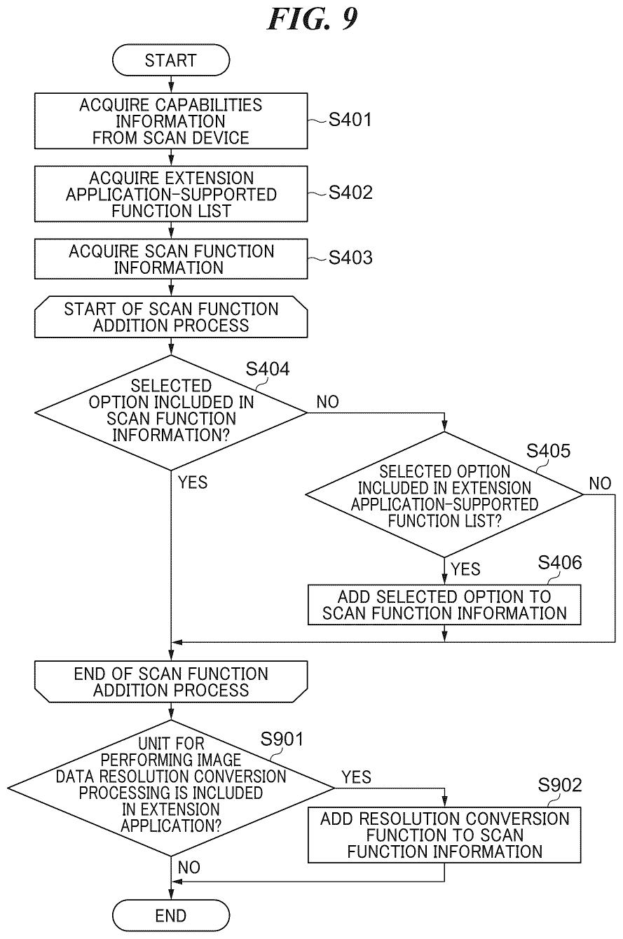

FIG. 9 is a flowchart of a scan function-editing process performed by the scan function-extending unit 206 in the second embodiment. Note that the steps in FIG. 9 are realized by the CPU 111 that executes the units loaded from the external storage device 114 into the RAM 113.

Similar to the process in FIG. 4, in the process in FIG. 9, the steps S401 to S406 are executed. Then, after execution of these steps, the process proceeds to a step S901. As described above, the scan device 102 does not support the resolution setting of 150×150 dpi. Therefore, the resolution setting of 15×150 dpi has not been added to the scan function information 203 after execution of the steps S404 to S406. On the other hand, the extension application 204 supports the resolution setting of 150×150 dpi.

In this case, in the step S901, the scan function-extending unit 206 determines, by consulting the table 501 shown in FIG. 5A and the scan function information 203, whether or not the extension application 204 has a unit that is capable of converting the resolution of the scanned image data to 150×150 dpi. If it is determined that the extension application 204 has the above-mentioned unit (YES in S901), the process proceeds to a step S902, whereas if it is determined that the extension application 204 does not include the above-mentioned unit (NO in S901), the present process is terminated. The extension application 204 in the present embodiment includes the image data-editing unit 207 capable of converting the resolution of image data, and hence the process proceeds to the step S902.

Next, in the step S902, the scan function-extending unit 206 adds the resolution setting of 150×150 dpi to the scan function information 203. Further, the scan function-extending unit 206 adds the resolution conversion function that converts the scanned image data of 300×300 dpi, which is read by the scan device 102, to image data of 150×150 dpi, using the image data-editing unit 207, to the scan function information 203. The resolution of the scanned image data as the target of resolution conversion by the resolution conversion function added here can be a resolution with which the scan device 102 is capable of performing reading and which exceeds 150×150 dpi, and for example, the resolution can be 600×600 dpi.

As described above, the scan function-extending unit 206, first, adds a function/option which is not supported by the general-purpose scan software 202 but is supported by both of the scan device 102 and the extension application 204 to the scan function information 203. After that, the scan function-extending unit 206 determines whether or not the extension application 204 can perform the processing for converting the resolution of the image data, and if the extension application 204 can perform the resolution conversion processing, the scan function-extending unit 206 adds the resolution conversion function to the scan function information 203. With this, the scan setting screen-extending unit 205 can display the resolution setting which is not supported by the general-purpose scan software 202 but is supported by the extension application 204 on the detailed setting screen 300C based on the capabilities information generated from the scan function information 203.

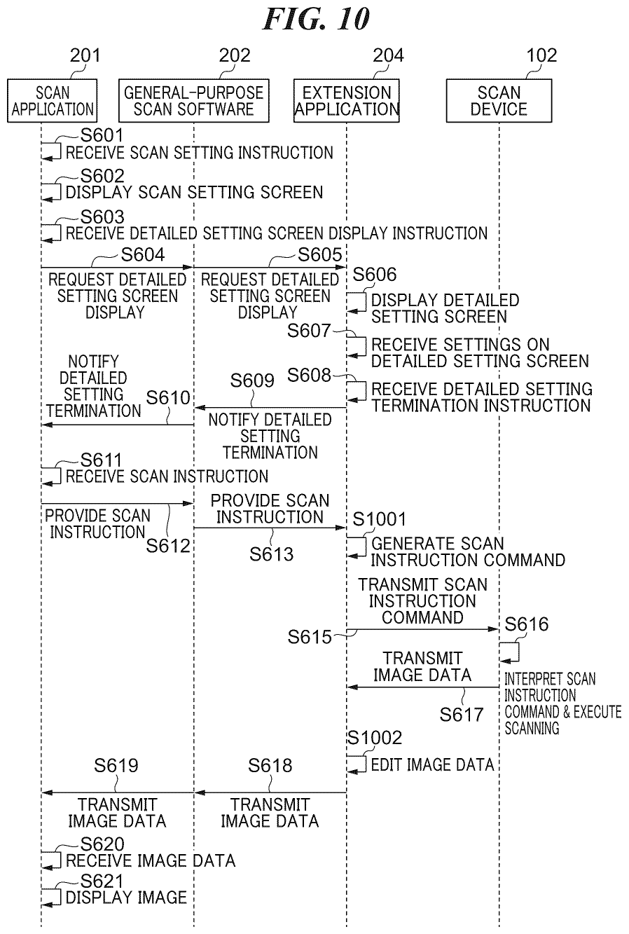

FIG. 10 is a sequence diagram showing a process executed between the scan application 201, the general-purpose scan software 202, the extension application 204, and the scan device 102, after the scan application 201 receives scan setting. Note that the steps in FIG. 10, other than the steps executed by the scan device 102, are performed by the CPU 111 that loads the scan application 201, the general-purpose scan software 202, and the extension application 204 from the external storage device 114 into the RAM 113 and executes the loaded units. The steps in FIG. 10, executed by the scan device 102, are realized by the CPU 191 of the scan device 102, which loads an associated program stored in the ROM 192 or the external storage device 199 into the RAM 193 and executes the loaded program.

Similar to the process in FIG. 6, as shown in FIG. 10, first, the steps S601 to S613 are executed. After that, a step S1001 is executed in place of the step S614, and a step S1002 is executed between the steps S617 and S618.

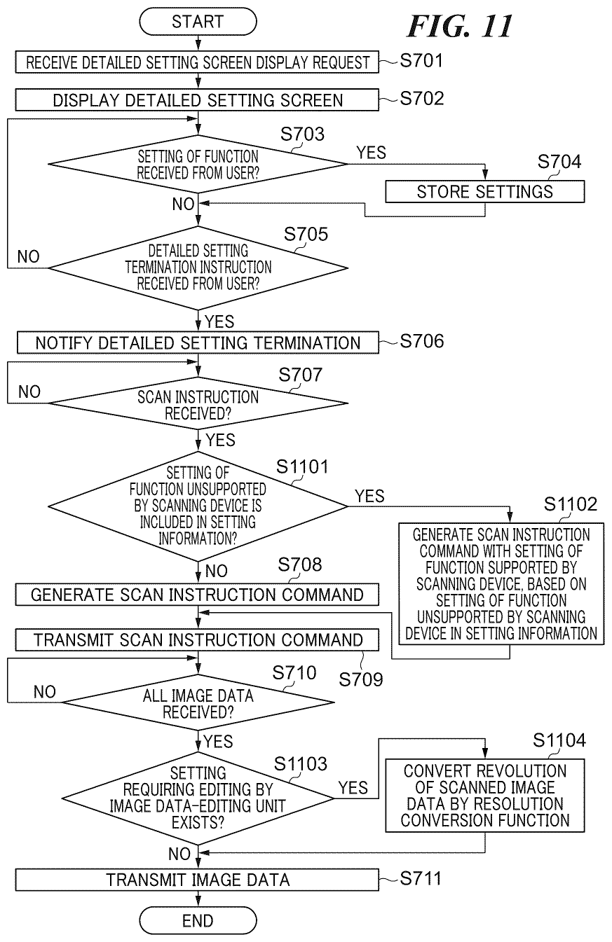

In the step S1001, the extension application 204 generates a scan instruction command. Details of the processing in the step S1001 will be described hereinafter with reference to a flowchart in FIG. 11.

In the step S1002, the image data-editing unit 207 of the extension application 204 performs image editing on the scanned image data transmitted from the scan device 102 in the step S617. In the present embodiment, in the step S1002, the scanned image data with the resolution of 300×300 dpi is converted to scanned image data of 150×150 dpi, by the resolution conversion processing. After that, the process proceeds to the step S618.

FIG. 11 is a flowchart showing the details of the process performed by the extension application 204 in the present embodiment. Note that the steps are realized by the CPU 111 that executes the units loaded from the external storage device 114 into the RAM 113.

As shown in FIG. 11, first, the steps S701 to S707 are executed similar to the process in FIG. 7. Then, as shown in FIG. 11, a step S1101 is executed between the steps S707 and S708. Depending on a result of determination in the step S1101, a step S1102 is executed. Further, a step S1103 is executed between the steps S710 and S711. Depending on a result of determination in the step S1103, a step S1104 is executed.

In the step S1101, the extension application 204 acquires the capabilities information of the scan device 102 from the shared information 208. Note that if the capabilities information of the scan device 102 is not included in the shared information 208, the scan function-extending unit 206 can request the capabilities information from the scan device 102 and store the acquired capabilities information in the shared information 208. The extension application 204 determines, based on the acquired capabilities information and a resolution selected by the user on the detailed setting screen 300C, whether or not the resolution selected by the user (setting information) is a resolution which cannot be executed by the scan device 102 (the function setting which is not supported). As a result of this determination, if the selected resolution is a resolution which is not supported by the scan device 102 (YES in S1101), the process proceeds to the step S1102, whereas if the selected resolution is a resolution which is supported by the scan device 102 (NO in S1101), the process proceeds to the step S708. In the present embodiment, the resolution (150×150 dpi) selected by the user is a resolution which is not supported by the scan device 102, and hence the process proceeds to the step S1102.

In the step S1102, the extension application 204 sets the function setting supported by the scan device 102 based on the resolution selected by the user (function setting which is not supported by the scan device 102) and generates a scan instruction command. Specifically, the extension application 204 sets a resolution (here, the resolution of 300×300 dpi) which is higher than the resolution (150×150 dpi) selected by the user, and at the same time which is supported by the scan device 102, and generates a scan instruction command. After that, the process proceeds to the step S709. Thus, by reading an image of an original with a resolution higher than the resolution selected by the user, it is possible to suppress deterioration of the image when the resolution is converted later.

In the step S1103, the extension application 204 determines whether or not there is a setting requiring editing by the image data-editing unit 207 based on the information (setting information) selected by the user on the detailed setting screen 300C. If there is a setting which is required to be edited by the image data-editing unit 207 (YES in S1103), the process proceeds to the step S1104, whereas if there is no setting which is required to be edited by the image data-editing unit 207 (NO in S1103), the process proceeds to the step S711. In the present embodiment, the resolution of 150×150 dpi, which is not supported by the scan device 102, is selected by the user on the detailed setting screen 300C, and hence the process proceeds to the step S1104.

In the step S1104, the image data-editing unit 207 converts the resolution of the scanned image data by the resolution conversion function added in the step S902 and then proceeds to the step S711.

T us, the description has been given of the case where a resolution which is not supported by the scan device 102 is selected by the user on the detailed setting screen 300C, but the same process is also performed with respect to a case where the scan device 102 does not support the resolution setting function. With respect to scanned image data read by the scan device 102 with a fixed resolution, the image data-editing unit 207 converts the resolution of the received image data based on the resolution setting made in the step S703.

As described above, in the present embodiment, even when a specific resolution is not supported by the scan device 102, or the resolution setting function is not supported by the scan device 102, it is possible to provide the resolution setting function to the user.

Next, a third embodiment of the present invention will be described. In the first and second embodiments, the extension application 204 and the scan device 102 communicate with each other.

On the other hand, in the present embodiment, the general-purpose scan software 202 communicates with the scan device 102, and the extension application 204 performs only processing operations for extending a scan instruction command and editing an image.

Note that the following description will be given only of differences from the first and second embodiments.

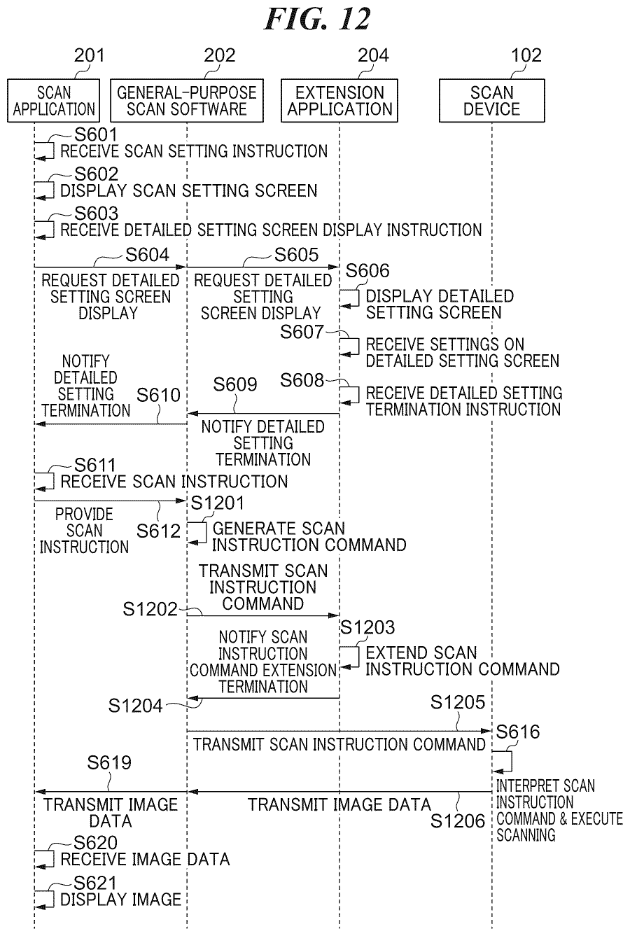

FIG. 12 is a sequence diagram of a process performed between the scan application 201, the general-purpose scan software 202, the extension application 204, and the scan device 102, after the scan application 201 receives scan setting. The steps in FIG. 12, other than the steps executed by the scan device 102, are performed by the CPU 111 that loads the scan application 201, the general-purpose scan software 202, and the extension application 204 from the external storage device 114 into the RAM 113 and executes the loaded units. The steps in FIG. 12, executed by the scan device 102, are realized by the CPU 191 of the scan device 102, which loads an associated program stored in the ROM 192 or the external storage device 199 into the RAM 193 and executes the loaded program.

As shown in FIG. 12, first, the steps S601 to S612 are executed similarly to the process in FIG. 6. After that, steps S1201 to S1205 are executed in place of the steps S613 to S615, and a step S1206 is executed in place of the steps S617 and S618.

In a step S1201, the general-purpose scan software 202 generates a scan instruction command. At this time, a scan function which is not supported by the general-purpose scan software 202 is not written in the scan instruction command.

In a step S1202, the general-purpose scan software 202 transfers the generated scan instruction command to the extension application 204.

In a step S1203, the extension application 204 extends the scan instruction command. Specifically, the extension application 204 adds an instruction command for the function which is not supported by the general-purpose scan software 202 to the scan instruction command received from the general-purpose scan software 202 in the step S1202, and changes existing instructions. In the present embodiment, the resolution setting is not included in the scan instruction command generated by the general-purpose scan software 202 in the step S1201, and hence the resolution setting is added.

In the step S1204, the extension application 204 transmits the scan instruction command which has been extended in the step S1203 to the general-purpose scan software 202 and notifies the general-purpose scan software 202 that the extension is terminated.

In the step S1205, the general-purpose scan software 202 transmits the scan instruction command received from the extension application 204 in the step S1204 to the scan device 102 to provide a scan instruction and then proceeds to the step S616.

In the step S1206, the general-purpose scan software 202 receives scanned image data from the scan device 102.

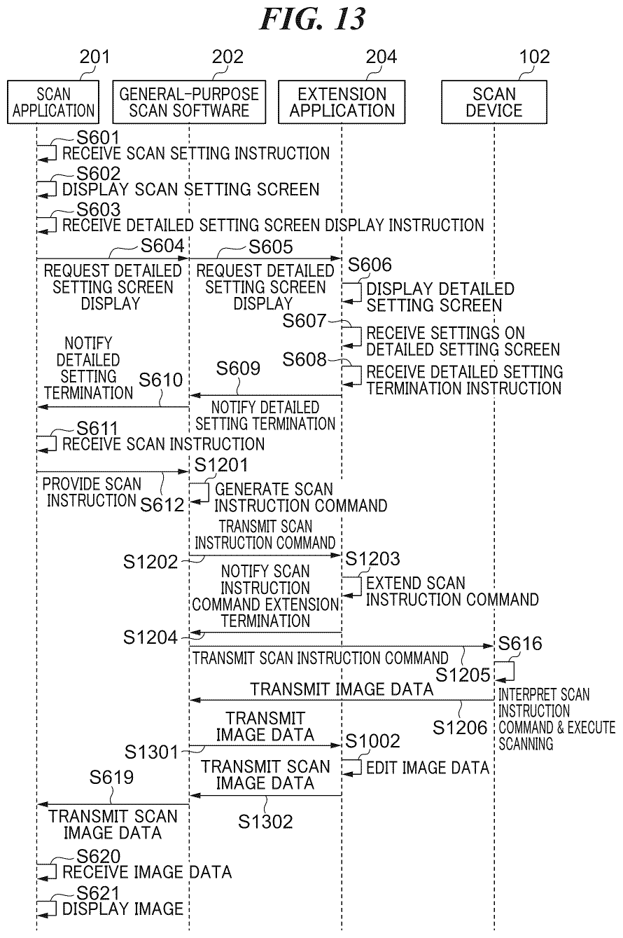

FIG. 13 is a sequence diagram showing a variation of the process in FIG. 12. In this variation, in a case where the general-purpose scan software 202 and the scan device 102 communicate with each other, image editing is performed by the extension application 204. The steps in FIG. 13, other than the steps executed by the scan device 102, are performed by the CPU 111 that loads the scan application 201, the general-purpose scan software 202, and the extension application 204 from the external storage device 114 into the RAM 113 and executes the loaded units. The steps in FIG. 13, which are executed by the scan device 102, are realized by the CPU 191 of the scan device 102, which loads an associated program stored in the ROM 192 or the external storage device 199 into the RAM 193 and executes the loaded program.

As shown in FIG. 13, a step S1301, the step S1002, and a step S1302 are sequentially executed between the step S1206 and the step S619.

In the step S1301, the general-purpose scan software 202 transmits scanned image data received from the scan device 102 in the step S1206, to the extension application 204.

In the step S1002, the image data-editing unit 207 of the extension application 204 edits the scanned image data received from the general-purpose scan software 202 in the step S1301. In the present embodiment, similar to the step S1104 in FIG. 11, in the step S1002, the image data-editing unit 207 converts the scanned image data with the resolution of 300×300 dpi to image data of 150×150 dpi by performing the resolution conversion processing.

In the step S1302, the extension application 204 transmits the image data obtained by the image editing in the step S1302 to the general-purpose scan software 202. After that, the process proceeds to the step S619.

As described above, in the present embodiment, the extension application 204 extends the scan instruction command. With this, if the set resolution is a resolution supported by the extension application 204, even when the set resolution is not supported by the scan device 102, it is possible to provide the resolution setting function to the user.

Next, a fourth embodiment of the present invention will be described. In the first, second, and third embodiments, a command used based on the standard protocol is extended and transmitted to the scan device 102.

In contrast thereto, in the present embodiment, the standard protocol command is not extended, and with respect to a function supported only by the extension application 204, another command is used to provide an instruction to the scan device 102.

Note that the following description will be given only of differences from the first, second and third embodiments.

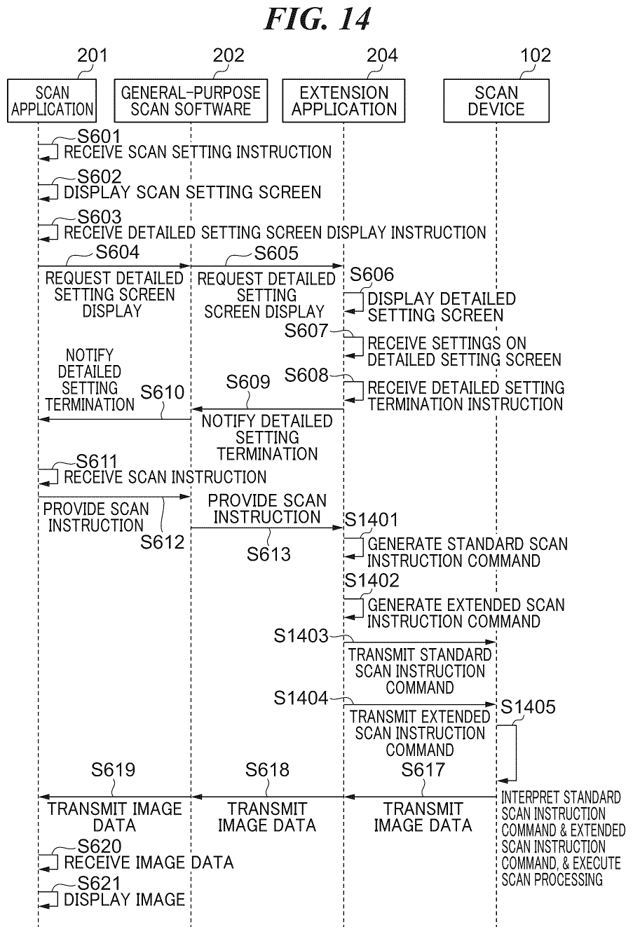

FIG. 14 is a sequence diagram of a process performed between the scan application 201, the general-purpose scan software 202, the extension application 204, and the scan device 102, after the scan application 201 receives scan setting. The steps in FIG. 14, other than the steps executed by the scan device 102, are performed by the CPU 111 that loads the scan application 201, the general-purpose scan software 202, and the extension application 204 from the external storage device 114 into the RAM 113 and executes the loaded units. The steps in FIG. 14, executed by the scan device 102, are realized by the CPU 191 of the scan device 102, which loads an associated program stored in the ROM 192 or the external storage device 199 into the RAM 193 and executes the loaded program.

Similar to the process in FIG. 6, as shown in FIG. 14, first, the steps S601 to S613 are executed. After that, steps S1401 to S1405 are executed in place of the steps S614 to S616.

In the step S1401, the extension application 204 generates a standard scan instruction command according to the standard protocol. At this time, a scan function which is not supported by the standard protocol is not written in the scan instruction command.

In the step S1402, the extension application 204 generates an extended scan instruction command with respect to a function which is supported only by the extension application 204.

In the step S1403, the extension application 204 transmits the standard scan instruction command generated in the step S1401 to the scan device 102 to provide a scan instruction.

In the step S1404, the extension application 204 transmits the extended scan instruction command generated in the step S1402 to the scan device 102 to provide an extended scan instruction.

In the step S1405, the scan device 102 interprets the standard scan instruction command and the extended scan instruction command, which are received from the extension application 204 in the steps S1403 and S1404, respectively, and executes scan processing. After that, the process proceeds to the step S617.

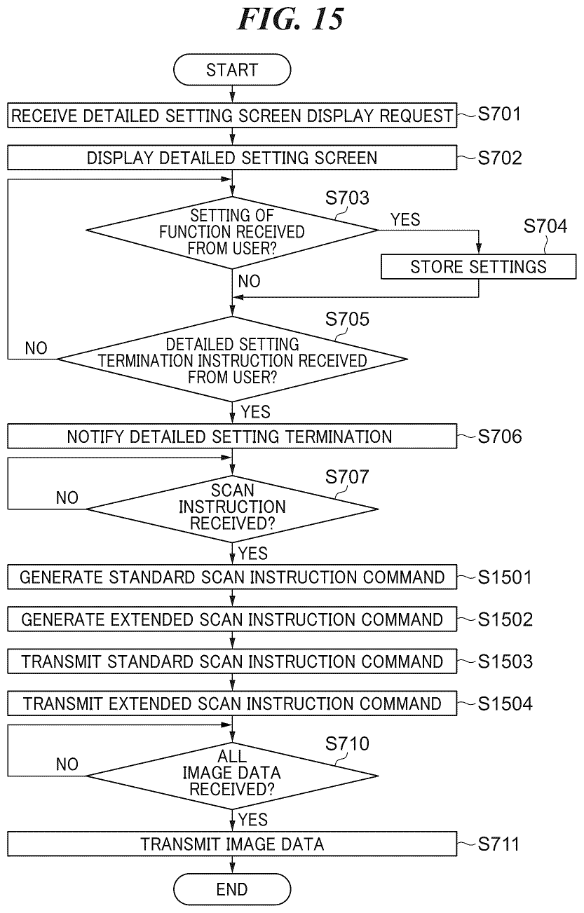

FIG. 15 is a flowchart of a process according to the present embodiment, which is performed by the extension application 204. The present process is realized by the CPU 111 that executes the units loaded from the external storage device 114 into the RAM 113.

As shown in FIG. 15, similar to the process in FIG. 7, first, the steps S701 to S707 are executed. After that, steps S1501 to S1504 are executed in place of the steps S708 and S709.

In a step S1501, the extension application 204 generates a standard scan instruction command according to the standard protocol.

In a step S1502, the extension application 204 generates an extended scan instruction command with respect to a function which is not supported by the standard protocol (extended instruction command).

In a step S1503, the extension application 204 transmits the standard scan instruction command generated in the step S1501 to the scan device 102.

In a step S1504, the extension application 204 transmits the extended scan instruction command generated in the step S1502 to the scan device 102. Then, the process proceeds to the step S710.

As described above, in the fourth embodiment, the other scan instruction command is transmitted from the extension application 204 with respect to a function which is not supported by the standard protocol, which makes it possible to provide the resolution setting function to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071327 filed Apr. 25, 2024, which is hereby incorporated by reference herein in its entirety.

What is claimed is:

1. A non-transitory computer-readable storage medium storing an application program supporting scan software which can be commonly used for image processing apparatuses of a plurality of makers, the application program being executed to thereby execute a method of controlling an information processing apparatus,
the method comprising:
displaying a setting screen for receiving a setting of a resolution of an image; and
instructing an image processing apparatus as one of the image processing apparatuses of the plurality of makers to read an image of an original, based on the set resolution,
wherein the display screen is capable of receiving the setting of the resolution, which cannot be designated by the scan software.

2. The storage medium according to claim 1, wherein the set resolution is one of a plurality of predetermined candidates for the resolution.

3. The storage medium according to claim 1, wherein the displaying of the display screen includes displaying only resolutions with which the image processing apparatus is capable of performing reading.

4. The storage medium according to claim 1, wherein the displaying of the display screen includes receiving a value input by a user on the display screen, as a value of the set resolution.

5. The storage medium according to claim 1, wherein the displaying of the display screen includes displaying a warning on the display screen in a case where the set resolution is equal to or higher than a predetermined resolution.

6. The storage medium according to claim 1, wherein the method further comprises, in a case where the reading of the original by the image processing cannot be executed with the set resolution, converting a resolution of the image data acquired through reading of the original by the image processing apparatus to the set resolution.

7. The storage medium according to claim 6, wherein the instructing to read the image includes, in a case where the reading of the original by the image processing cannot be executed with the set resolution, instructing the image processing apparatus to read the image of the original with a resolution which is higher than the set resolution and is supported by the image processing apparatus.

8. The storage medium according to claim 1, wherein the instructing the image processing apparatus to read the image of the original includes generating an instruction command by extending an instruction command of a standard instruction protocol, using a command for a function which is not supported by the standard instruction protocol, and transmitting the instruction command to the image processing apparatus.

9. The storage medium according to claim 1, wherein the instructing the image processing apparatus to read the image of the original includes adding, to an instruction command of a standard instruction protocol, an extended instruction command for a function which is not supported by the standard instruction protocol, and then transmitting the resulting instruction command to the image processing apparatus.

10. The storage medium according to claim 1, wherein the instructing the image processing apparatus to read the image of the original includes generating an instruction command of a standard instruction protocol and an extended instruction command concerning a function which is not supported by the standard instruction protocol, and transmitting the instruction command and the extended instruction command to the image processing apparatus.

11. The storage medium according to claim 2, wherein the displaying of the display screen includes changing an item to be displayed on the display screen, out of the plurality of predetermined candidates for the resolution, based on a combination with another function.

12. The storage medium according to claim 2, wherein the displaying of the display screen includes acquiring capabilities information of the image processing apparatus, and changing an item to be displayed on the display screen, out of the plurality of predetermined candidates for the resolution.

13. A method of controlling an information processing apparatus that performs control for supporting scan software which can be commonly used for image processing apparatuses of a plurality of makers, comprising:
displaying a setting screen for receiving a setting of a resolution of an image; and
instructing an image processing apparatus as one of the image processing apparatuses of the plurality of makers to read an image of an original, based on the set resolution,
wherein the display screen is capable of receiving a setting of the resolution, which cannot be designated by the scan software.

14. An information processing apparatus that is connected to image processing apparatuses of a plurality of makers, and is capable of processing information between the information processing apparatus and an image processing apparatus as one of the image processing apparatuses of the plurality of makers, comprising:
scan software which can be commonly used for the image processing apparatuses of the plurality of makers; and
an application program supporting the scan software,
wherein the application program causes a computer of the information processing apparatus to:
display a display screen for receiving a setting of a resolution of an image; and
instruct the image processing apparatus to read an image of an original, based on the set resolution,
wherein the display screen is capable of receiving a setting of the resolution, which cannot be designated by the scan software.
